(19) United States
(12) Patent Application Publication
(10) Pub. No.: US 2006/0152869 A1
(43) Pub. Date: Jul. 13, 2006

(54) PRINTED CIRCUIT BOARD CAPABLE OF RESISTING ELECTROSTATIC DISCHARGE AND ROUTING METHOD THEREOF

(76) Inventors: Chih-Chiang Su, Kao-Hsiung Hsien (TW); Chieh-Chih Liu, Keelung City (TW); Wei-Chih Liu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/163,574

(22) Filed: Oct. 24, 2005

(30) Foreign Application Priority Data
Jan. 12, 2005 (TW) 094100847

(51) Int. Cl. H02H 9/00

(52) U.S. Cl. 361/56

(57) ABSTRACT

A printed circuit board capable of resisting electrostatic discharge and a routing method of the one or multi-layer printed circuit board are disclosed. The routing method includes planning a first routing area, planning a second routing area apart from the first routing area for a predetermined distance at least, and connecting an attenuating component between the first routing area and the second routing area for attenuating an impulse generated by electrostatic discharge in order to prevent the impulse spreading to the second routing area from the first routing area.

### BACKGROUND OF THE INVENTION

1. Field of the Invention

The invention relates to a printed circuit board and a related routing method, and more particularly, to a printed circuit board capable of resisting electrostatic discharge and a related routing method.

2. Description of the Prior Art

To improve the reliability of electronic products available on the market, before a product can be sold officially it must pass several kinds of safety tests to obtain a serial number that represents the product meets safety requirements. Every country, no matter whether in Europe, America, or Asia, has their own safety standards. For example, some common safety standards tests are Electro Magnetic Interference (EMI) test, Electro Magnetic Susceptibility (EMS) test, and Electrostatic Discharge (ESD) test.

The electrostatic discharge test simulates the effects of static electricity moving from the human body or portable tools to the electronic product to be tested. According to the standard IEC61000-4-2, the test methods are divided into 1) air discharge method and 2) contact discharge method. The air discharge method comprises moving an ESD simulator toward the isolating surface of the tested product, utilizing the ESD simulator to discharge on the isolating surface with a test voltage between 2-15 kV, and letting the ESD simulator touch a test point on the electronic product after discharging, so as to spread a current to the tested product. The contact discharge method comprises letting the ESD simulator touch the test point, and utilizing the ESD simulator to discharge on the test point. The test point of the contact discharge method may be a screw, a visible connector, or any visible metal part of the tested product. The test voltage of the contact discharge method is 2-8 kV.

To alleviate the damage caused by the air discharging, the shell of the tested product is made from an electric conductive compound material. The electric conductive compound material is an isolated plastic material mixed with conductive material to achieve the objectives of conductivity and prevention of electrostatic discharge. Common conductive materials are carbon powder, carbon fiber, metal fiber, and metal powder. Therefore, the electric conductive compound material will not generate a lot of static electricity, and will eliminate the stored static electricity before the stored static electricity can cause damage.

The method for preventing contact discharge is more complex than the method for preventing air discharge, because the static electricity will spread to the printed circuit board from the visible I/O connector, such as a power jack. If there is no protective circuit to guide the static electricity to the ground terminal of the I/O connector, the static electricity may break the IC on the printed circuit board and cause irreparable damage to the electronic product.

### SUMMARY OF THE INVENTION

It is therefore an objective of the claimed invention to provide a printed circuit board capable of resisting electrostatic discharge, and a related routing method to reduce the damage caused by the electrostatic discharge to the electronic product.

According to the claimed invention, a routing method capable of resisting an electrostatic discharge applied in a printed circuit board is disclosed. The routing method comprises: planning a first routing area; planning a second routing area, wherein the distance between the first routing area and the second routing area is not smaller than a predetermined distance; and connecting an attenuating component between the first routing area and the second routing area, wherein the attenuating component is utilized to attenuate a pulse generated by electrostatic discharge, in order to prevent the impulse spreading to the second routing area from the first routing area.

According to the claimed invention, a printed circuit board capable of resisting an electrostatic discharge is disclosed. The printed circuit board comprises: a first routing area, for routing an I/O connector; a second routing area, for routing an electronic component on the printed circuit board, wherein the distance between the first routing area and the second routing area is not smaller than a predetermined distance; and an attenuating component, electrically connected between the first routing area and the second routing area, for attenuating a pulse generated by an electrostatic discharge, and for preventing the pulse being transmitted to the second routing area from the first routing area.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of the printed circuit board according to a preferred embodiment of the present invention.

FIG. 2 is a flow chart of the routing method capable of resisting the electrostatic discharge according to a preferred embodiment of the present invention.

### DETAILED DESCRIPTION

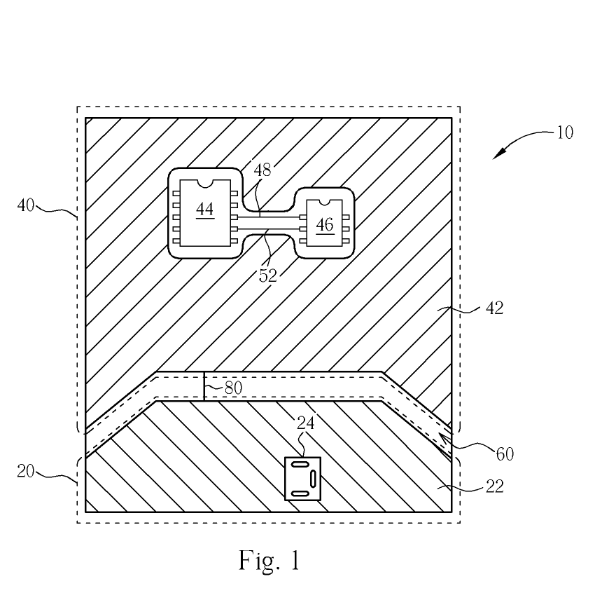

Please refer to FIG. 1. FIG. 1 is a schematic diagram of the printed circuit board 10 according to a preferred embodiment of the present invention. The printed circuit board 10 is a single- or multi-layer printed circuit board, and includes a plurality of routing areas 20, 40, a gap (i.e., the area where metal is absent) 60, and a attenuating component 80. The routing areas 20, 40 are located on the same layout layer according to the present embodiment. A conductive metal layer (i.e., the area with oblique lines) 22 and an I/O connector 24 are placed on the routing area 20. The I/O connector 24 is utilized to connect an outside device of the one or multi-layer printed circuit board 10. A conductive metal layer (area with oblique lines) 42, a plurality of ICs 44, 46, and a plurality of printed wires 48, 52 are placed at the routing area 40. The printed wires 48 and 52 are utilized to connect the ICs 44 and 46. In the present embodiment, the conductive metal layers 22, 42 correspond to a copper pour area of the printed circuit board 10 for proving a ground terminal to all devices on the printed circuit board 10. The copper pour area is separate from the printed wires 48, 52 and the pads of the ICs 44,46 in order to avoid generating a short circuit. Since the method of copper pouring is well known to those skilled in the art, the description of copper pouring is omitted for the sake of brevity. Please note that every ground pin and shielding pin of the ICs 44, 46 or the I/O connector 24 is connected to the conductive metal layer 22 or 42.

Gap 60 separates the routing areas 20 and 40. In the present embodiment, the minimum width of the gap 60 is 1.25 mm, and the I/O connector 24 is a power jack or an earpiece jack. When performing the electrostatic discharge test, the static electricity may spread to the conductive metal layer 22 from the ground pin or shielding pin of the I/O connector 24. Since the gap 60 separates the conductive metal layers 22, 42, the static electricity will not spread to the conductive metal layer 42 from the conductive metal layer 22. As a result, the ICs 44, 46 located on the routing area 40 are protected by the gap 60. Please note that the minimum width of the gap corresponds to the material, thickness, and other characteristics of the printed circuit board 10, and is not limited to the present embodiment. When the width of the gap 60 is not wide enough, the static electricity may discharge to the conductive metal layer 42 from a peak of the conductive metal layer 22.

However, if the ground terminals of the routing areas 20, 40 are not connected to each other, the ground voltages of the routing areas 20, 40 may float. Therefore an attenuating component 80 is utilized to connect the conductive metal layers 22, 42 to equalize the DC voltages of the conductive metal layer 22, 42 and to attenuate a pulse pass through the attenuating component 80. Please note that the immediately occurring static electricity is treated as a pulse, and includes a plurality of high-frequency signals in the view of the frequency spectrum. Hence, when the routing area 20 experiences a pulse, the largest part of the pulse cannot pass through the attenuating component 80 and therefore cannot arrive at the routing area 40. Even when a smaller part of the pulse signal passes through the attenuating component 80 and arrives at the routing area 40, the effect of the passed signal is very weak.

In the present embodiment, the attenuating component 80 is a printed wire whose maximum wire width is 0.1 mm, because the thinner wire is an equivalent inductor to the high-frequency signals. As a result, the printed wire is capable of preventing the high-frequency signals from passing through. Pleas note that the maximum wire width of the printed wire corresponds to the material, thickness, and other characteristics of the printed circuit board 10, and is not limited to the present embodiment. In addition, the attenuating component 80 may be a copper wire, a zero ohm resister, a real inductor, or other components capable of attenuating high-frequency signal according to the present invention.

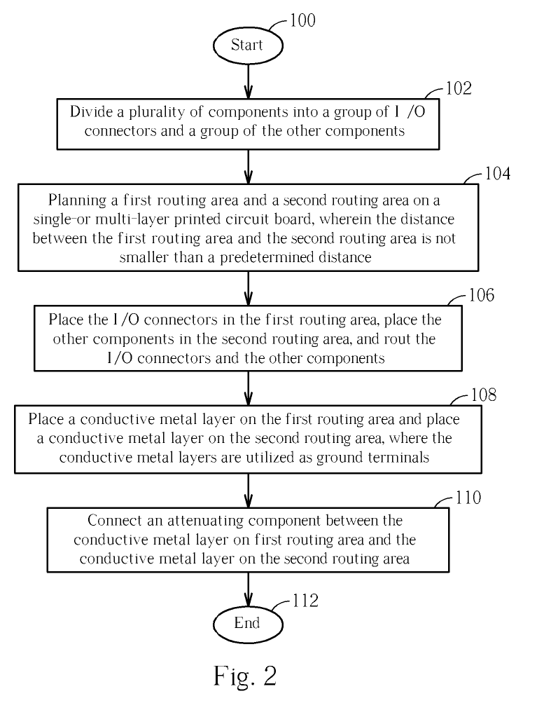

Please refer to FIG. 2. FIG. 2 is a flow chart of the routing method capable of resisting the electrostatic discharge according to a preferred embodiment of the present invention. The routing method includes the following steps.

Step 100: start.

Step 102: divide a plurality of components into a group of I/O connectors and a group of the other components.

Step 104: plan a first routing area and a second routing area on a single- or multi-layer printed circuit board, wherein the distance between the first routing area and the second routing area is not smaller than a predetermined distance.

Step 106: place the I/O connectors in the first routing area, place the other components in the second routing area, and rout the I/O connectors and the other components.

Step 108: place a conductive metal layer on the first routing area and place a conductive metal layer on the second routing area, where the conductive metal layers are utilized as ground terminals.

Step 110: connect an attenuating component between the conductive metal layer on the first routing area and the conductive metal layer on the second routing area.

Step 112: end.

Please note that the predetermined distance mentioned in step 104 is the minimum width of the gap 60 shown in FIG. 1.

In summary, the present invention provides a gap to separate more than two routing areas of the single- or multi-layer printed circuit board. The I/O connectors shown in the outward appearance of a product are placed in a different routing area to the routing area for placing the other components, so as to prevent the other components from being influenced by the electrostatic discharge coming from the I/O connectors. In addition, an attenuating component is utilized to connect the ground terminals of different routing areas according to the present invention, in order to prevent the ground voltages from floating. Since the attenuating component utilized in the present invention is very cheap and easily obtained, the cost of manufacturing is significantly reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A routing method capable of resisting an Electrostatic Discharge (ESD) applied on a printed circuit board (PCB), the method comprising:
planning a first routing area;
planning a second routing area, wherein the distance between the first routing area and the second routing area is not smaller than a predetermined distance; and
connecting an attenuating component between the first routing area and the second routing area, wherein the attenuating component is utilized to attenuate a pulse generated by electrostatic discharge, in order to prevent the impulse spreading to the second routing area from the first routing area.

2. The routing method of claim 1, wherein the first routing area comprises a first ground terminal, the second routing area comprises a second ground terminal, and the attenuating component is electrically connected between the first ground terminal and the second ground terminal.

3. The routing method of claim 2, wherein the step of planning the first routing area comprises:
generating the first ground terminal by placing a first conductive layer in the first routing area;
the step of planning the second routing area comprises:
generating the second ground terminal by placing a second conductive layer in the second routing area.

4. The routing method of claim 3, wherein the first conductive layer and the second conductive layer correspond to copper pour areas.

5. The routing method of claim 3, wherein the first conductive layer is electrically connected to a ground pin or a shielding pin of an I/O connector, and the second conductive layer is electrically connected to a ground pin of at least one electronic component.

6. The routing method of claim 1, wherein the first routing area and the second routing area are located on the same layout layer of the printed circuit board.

7. The routing method of claim 1, wherein the first routing area and the second routing area are located on different layout layers of the printed circuit board.

8. The routing method of claim 1, wherein the attenuating component is a printed wire and the width of the printed wire is not greater than a predetermined wire width.

9. The routing method of claim 1, wherein the attenuating component is an inductor.

10. The routing method of claim 1, wherein the attenuating component is a resistor.

11. The routing method of claim 1, wherein the attenuating component is made from copper.

12. The routing method of claim 1, wherein the printed circuit board is a single- or multi-layer printed circuit board.

13. A printed circuit board capable of resisting an Electrostatic Discharge (ESD), the printed circuit board comprising:
a first routing area, for routing an I/O connector;
a second routing area, for routing an electronic component on the printed circuit board, wherein the distance between the first routing area and the second routing area is not smaller than a predetermined distance; and
an attenuating component, electrically connected between the first routing area and the second routing area, for attenuating a pulse generated by a electrostatic discharge and for preventing the pulse transmitted to the second routing area from the first routing area.

14. The printed circuit board of claim 13, wherein the first routing area comprises a first conductive layer electrically connected to a ground pin or a shielding pin of the I/O connector; the second routing area comprises a second conductive layer electrically connected to a ground pin of the electronic component; and the attenuating component is electrically connected between the first conductive layer and the second conductive layer.

15. The printed circuit board of claim 14, wherein the first conductive layer and the second conductive layer correspond to copper pour areas.

16. The printed circuit board of claim 14, wherein the first routing area and the second routing area are located on the same layout layer of the printed circuit board.

17. The printed circuit board of claim 14, wherein the first routing area and the second routing area are located on different layout layers of the one or multi-layer printed circuit board.

18. The printed circuit board of claim 13, wherein the attenuating component is a printed wire and the width of the printed wire is not greater than a predetermined wire width.

19. The printed circuit board of claim 13, wherein the attenuating component is an inductor.

20. The printed circuit board of claim 13, wherein the attenuating component is a resistor.

21. The printed circuit board of claim 13, wherein the attenuating component is made from copper.

22. The printed circuit board of claim 13, wherein the printed circuit board is a single- or multi-layer printed circuit board.
